(19) United States
(12) Patent Application Publication
(10) Pub. No.: US 2023/0233416 A1
(43) Pub. Date: Jul. 27, 2023

(54) PACIFIER

(71) Applicant: VIVOLAB AB, Falun (SE)

(72) Inventors: Lars THELIN, Falun (SE); Fredrik BOKVIST, Svardsjo (SE)

(73) Assignee: VIVOLAB AB, Falun (SE)

(21) Appl. No.: 18/001,761

(22) PCT Filed: Jun. 14, 2021
(86) PCT No.: PCT/SE2021/050574

§ 371 Date: Dec. 14, 2022

(30) Foreign Application Priority Data
Jun. 15, 2020 (SE) 2050716-6

(51) Int. Cl. A61J 17/00; A61J 7/00

(52) U.S. Cl. CPC A61J 17/001; A61J 17/105; A61J 7/0053

(57) ABSTRACT

A pacifier comprising a suction part and a housing part, wherein said suction part comprises a nipple and a shield connected to each other, wherein said suction part comprises a passageway through which a fluid can pass from outside a mouth of a user of the pacifier to inside the mouth of the user of the pacifier, and wherein said housing part comprises a housing, wherein said housing comprises a drug compartment which is prefilled with a drug which can pass through the passageway into the mouth of the user when the housing part is connected to said suction part, wherein said pacifier further comprises a drug collection cup which is positioned in the pacifier and configured for collecting drug released from the drug compartment before the drug is received by a user and wherein said drug collection cup comprises a valve which is configured to open up and let fluid pass when a user of the pacifier sucks on the nipple.

### TECHNICAL FIELD

The present invention relates to a pacifier, an exchangeable housing part configured to be used in a pacifier and to a pacifier system.

### BACKGROUND

Feeding of drugs to children can often be problematic. The use of a specifically designed pacifier for feeding drugs through the pacifier has been described before in for example U.S. Pat. Nos. 5,512,047 and 6,110,193. In both these patent applications a drug can be filled into the pacifier and a cap can be attached for sealing the drug inside the pacifier. The drug can travel through the nipple of the pacifier into the user's mouth. In EP1625843 another type of pacifier is disclosed where a cap part comprising a drug container can be attached to a nipple part of the pacifier. The drug is sealed inside the drug container by a film which is teared open when the cap part is attached to the nipple part. There may be problems related to how to move the drug from the cap part to the nipple part and problems related to dosage of the drug.

There is a need for more user friendly pacifiers for feeding of drugs.

Furthermore, air pollution is a problem. For many years, clean air was regarded as an unlimited resource. However, increasing global air pollution, has directed our attention to technologies related to the improvement of the air we breathe. In its simplest form, individuals in heavily polluted cities have become accustomed to avoiding being outdoors during certain hours of the day or periods of the year, or to wearing breathing masks similar to what is worn in hospitals to avoid infections to spread. In humans, the nose receives and expels air for respiration alongside the mouth. Hair inside the nostrils will filter incoming air, as a first line of defence against dust particles, smoke, and other potential obstructions that would otherwise inhibit respiration, and as a kind of filter against airborne illness. In addition to acting as a filter, mucus contributes moisture to integral components of the respiratory system. The nasal area also heats the incoming air to optimal levels for the body. Thus, by acting as the first interface between the external environment and the delicate lungs, a human nose will condition incoming air, both as a function of thermal and moist regulation and filtration during respiration.

The mouth, on the other hand, is incapable of defending the lungs—breathing through the mouth will expose the lungs to polluted and/or infected air and will also expose the lungs to dry, cold air which can have detrimental effects, especially in small children.

EP 1 009 362 (Hadasit Medical Research) relates to a device that will enable its user to bypass any obstruction in the nasal airways and maintain an open channel to the ambient air. More specifically, this is achieved by providing a pacifier comprising: a nipple consisting of a nipple head and a nipple neck, a shield fixedly attached to, or integral with, said nipple neck, said nipple head being provided with at least one first opening adapted to communicate with the free atmosphere. Further, the pacifier is a breathe-through pacifier having an ambient air open channel between said at least one first opening and the atmosphere so that a user of the pacifier is able to inhale exclusively through the at least one first opening, sufficiently for breathing, whereby any obstruction in the nasal airways is bypassed. It is possible to provide the nipple with a one-way valve sensitive enough to respond to a minimal respiratory effort, but not permitting exhaled air to enter the nipple, thereby preventing the deposition therein of mucous substances. In this case, exhaled air will simply escape between the baby's lips and shield of the pacifier.

US2003034031 (Sleep Up Ltd.) describes a pacifier which facilitates mouth breathing. The pacifier is constructed such that sucking causes an air flow valve to assume a first operational state in which a channel of fluid communication is closed and cessation of sucking allows said air flow valve to assume a second operational state in which said channel of fluid communication is open.

Despite the available technology, there is still a need in the area of pacifiers for improved devices, which are easy to use, not too costly to produce and which are capable of delivering drugs and possibly also improving and conditioning inhaled air in multiple ways.

### SUMMARY

An object of the present invention is to provide an improved pacifier.

A further object of the present invention is to provide an improved pacifier for delivering of drugs.

A further object of the present invention is to provide a pacifier system which is capable of both delivering drugs and improving and conditioning inhaled air.

A further object of the present invention is to provide a more versatile and user friendly pacifier.

This is achieved by a pacifier, an exchangeable housing part and a pacifier system according to the independent claims.

According to one aspect of the invention a pacifier comprising a suction part and a housing part is provided, wherein said suction part comprises a nipple and a shield connected to each other, wherein said suction part comprises a passageway through which a fluid can pass from outside a mouth of a user of the pacifier to inside the mouth of the user of the pacifier, and wherein said housing part comprises a housing, wherein said housing comprises a drug compartment which is arranged to be prefilled with a drug which can pass through the passageway into the mouth of the user when the housing part is connected to said suction part, wherein said pacifier further comprises a drug collection cup which is positioned in the pacifier and configured for collecting drug released from the drug compartment before the drug is received by a user and wherein said drug collection cup comprises a valve which is configured to open up and let fluid pass when a user of the pacifier sucks on the nipple.

Hereby drug can be delivered through the pacifier to a user of the pacifier in a controlled way. The delivery of the drug through the pacifier is controlled by the user by sucking on the nipple of the pacifier. The valve of the drug collection cup will require a user to suck on the nipple for releasing the drug and hereby an accidental inhaling of the drug is minimized. By collecting the drug in a drug collection cup before it is transferred further to the user the delivery and dosage of the drug is better controlled.

According to another aspect of the invention an exchangeable housing part configured to be used in a pacifier as defined above is provided, wherein said housing part comprises a housing and at least one second connection device which is releasably connectable to at least one first connection device provided in the suction part, wherein said housing part comprises a housing, wherein said housing comprises a drug compartment which is arranged to be prefilled with a drug which can pass through the passageway into the mouth of the user when the housing part is connected to said suction part, wherein said pacifier further comprises a drug collection cup which is positioned in the pacifier and configured for collecting drug released from the drug compartment before the drug is received by a user and wherein said drug collection cup comprises a valve which is configured to open up and let fluid pass when a user of the pacifier sucks on the nipple.

According to another aspect of the invention a pacifier system comprising a reusable suction part and at least two exchangeable housing parts is provided.

In some embodiments of the invention the suction part is a reusable part and the housing part is an exchangeable part, wherein said reusable suction part and said exchangeable housing part are releasable connectable to each other, wherein said suction part comprises at least one first connection device and wherein said housing part comprises at least one second connection device which is releasably connectable to the at least one first connection device.

Hereby a versatile pacifier is achieved. The suction part can be reused and connected to different housing parts. Hereby for example housing parts comprising different types of drugs or different doses of the drug can be attached to and used together with the same suction part. Furthermore, the drug can be delivered in a controlled way with the pacifier according to the invention.

In some embodiments of the invention walls of said drug collection cup are made from a flexible material. Hereby the drug collection cup can collapse for delivering the drug when the user sucks on the nipple. Possibly the drug collection cup can also expand when the drug is delivered from the drug compartment into the drug collection cup.

In some embodiments of the invention the pacifier further comprises a drug transferring tube which is extending from the drug collection cup through at least a part of the nipple of the suction part, wherein said drug transferring tube is less flexible than the nipple whereby drug can be transferred through the drug transferring tube even if the nipple is compressed. Hereby the user of the pacifier can compress the nipple when sucking on the pacifier and still drug can be delivered through the pacifier via the drug transferring tube.

In some embodiments of the invention the pacifier further comprises a drug releasing device by which an opening can be provided into the drug compartment, which drug releasing device can be operated from outside the pacifier. Hereby the drug can be released from the drug compartment right before the drug should be delivered to a user of the pacifier.

In some embodiments of the invention said housing comprises at least one air inlet, whereby air can be drawn into the drug compartment through said air inlet by a user of the pacifier when the user is sucking on the nipple of the suction part. By providing an air inlet to the housing such that air can be drawn into the drug compartment by the user of the pacifier when sucking on the nipple it can be avoided that a vacuum is built up in the drug compartment. Hereby drug can be delivered through the pacifier to the user in a controlled way.

In some embodiments of the invention a capillary tube is provided at an outlet from the drug compartment for transferring the drug out from the drug compartment. Hereby a transferring of the drug out from the drug compartment can be controlled. The dimensions of the capillary tube can be configured for a suitable drug transferring rate.

In some embodiments of the invention the drug is provided inside a capsule having a breakable capsule cover.

In some embodiments of the invention the drug capsule has a size such that the capsule will be compressed and broken when the suction part and the housing part are connected.

In some embodiments of the invention said housing part further comprises at least one piercing member arranged for piercing a drug capsule in which said drug is provided when said housing part is provided in a certain position in relation to the suction part hereby allowing the drug to be released at a certain moment.

In some embodiments of the invention said drug is provided in more than one drug capsule and said housing part can be provided in more than one different positions in relation to the suction part whereby said piercing member will be piercing one drug capsule in each of said positions.

In some embodiments of the invention said passageway comprises a first end and a second end between which a fluid can pass, which first end is provided at a first connection interface of the suction part configured for mating with a second connection interface of the housing part and which second end of the passageway is provided in a part of the nipple which is configured to be positioned within a user's mouth during use of the pacifier, whereby a fluid can pass through the passageway between the first connection interface of the suction part and the inside of a user's mouth during use of the pacifier.

In some embodiments of the invention the housing of the housing part comprises an interior space which is defined by a lid, surrounding walls and a second connection interface which is provided opposite the lid, wherein said second connection interface is configured for mating with the first connection interface of the suction part.

In some embodiments of the invention the suction part or the housing part, comprises at least one protruding part which will push a second connection interface of the housing part which is configured to mate with a first connection interface of the suction part, towards a lid of the housing part when the housing part and the suction part are connected whereby a pressure will be provided to an interior space of the housing comprising the drug, said interior space being provided between the second connection interface and the lid. Said pressure can both be used for breaking a drug capsule and for transferring the drug through the pacifier.

In some embodiments of the invention said air inlet is provided with at least one valve such that passage of air via said at least one air inlet only is admitted into and not out from said housing.

In some embodiments of the invention at least one separate air channel is provided in the housing part, wherein said at least one separate air channel is provided in fluid connection to at least one open air inlet of the housing part which is not in communication with a drug compartment of the housing where the drug initially is provided and wherein said open air inlet is open for passage of air in both directions. Hereby a user of the pacifier can both inhale and exhale through the pacifier.

In some embodiments of the invention said housing of said housing part comprises a pressurized chamber which can be activated for providing a pressure to the drug for transferring the drug to the passageway of the suction part. Hereby an additional pressure can be provided which may be suitable for advancing the drug through the pacifier.

In some embodiments of the invention said pressurized chamber comprises a releasing device, whereby said releasing device can be moved by an air flow provided through the pacifier during inhalation by a user, whereby said pressurized chamber is activated by a movement of said releasing device for providing a pressure to the drug for transferring the drug to the passageway of the suction part, possibly via a drug collection cup. Hereby, release of the drug can be controlled to be provided only when the user is not inhaling, i.e. the pressurized chamber is only activated when there is no air flow through the pacifier.

Further embodiments are described in the dependent claims and in the detailed description.

### BRIEF DESCRIPTION OF THE DRAWINGS

FIG. 1a shows schematically in cross section a pacifier according to one embodiment of the invention in an assembled position. FIG. 1b shows the same pacifier as in FIG. 1a but in a separated position.

FIG. 2a is a schematic cross section of a pacifier according to one embodiment of the invention.

FIG. 2b is an exploded view of a pacifier according to another embodiment of the invention. FIG. 2c is a cross section of the housing part of the same pacifier as shown in FIG. 2b.

FIG. 2d is an exploded view of a pacifier according to another embodiment of the invention.

FIG. 2e is an exploded view of a pacifier according to another embodiment of the invention. FIG. 2f shows two cross sections of the housing part of the same pacifier as shown in FIG. 2e in two different positions.

FIG. 3a is an exploded view of another pacifier according to one embodiment of the invention. FIGS. 3b and 3c are cross sections of a housing part of the pacifier as shown in FIG. 3a as assembled in two different positions. FIGS. 3d and 3e show a drug collection cup in two different positions.

FIG. 4a is an exploded view of a pacifier according to another embodiment of the invention. FIGS. 4b and 4c are cross sections of a housing part of the pacifier as shown in FIG. 4a as assembled and in two different positions. FIG. 4d is a cross section of the suction part of the pacifier as shown in FIG. 4a.

FIG. 5a is an exploded view of a housing part of a pacifier according to one embodiment of the invention. FIG. 5b is an exploded view of a part of a pacifier which can be used for example together with the housing part shown in FIG. 5a.

FIGS. 5c-f show cross sections of a pacifier according to another embodiment of the invention in different states of drug delivering.

FIG. 6a is a cross section of a pacifier according to one embodiment of the invention in a first, not completely connected position. FIG. 6b is a cross section of the same pacifier as shown in FIG. 6a in a second, completely connected position.

FIG. 7a is a cross section of a suction part according to one embodiment of the invention. FIGS. 7b and 7c are cross sections of a pacifier comprising the suction part as shown in FIG. 7a and a housing part as shown in FIG. 2b.

FIG. 8a shows schematically in cross section a pacifier according to one embodiment of the invention in an assembled position. FIG. 8b shows the same pacifier as in FIG. 8a but in a separated position.

FIG. 9a shows schematically in cross section a pacifier according to another embodiment of the invention in an assembled position. FIG. 9b shows the same pacifier as in FIG. 9a but in a separated position.

FIG. 10 shows schematically in cross section a pacifier according to another embodiment of the invention in a separated position.

FIG. 11a is an exploded view of a pacifier according to one embodiment of the invention. FIG. 11b shows a connection mechanism which can be used for connecting a suction part and a housing part of a pacifier according to one embodiment of the invention.

FIG. 12 show some examples of a pacifier system according to the invention.

### DETAILED DESCRIPTION OF EMBODIMENTS

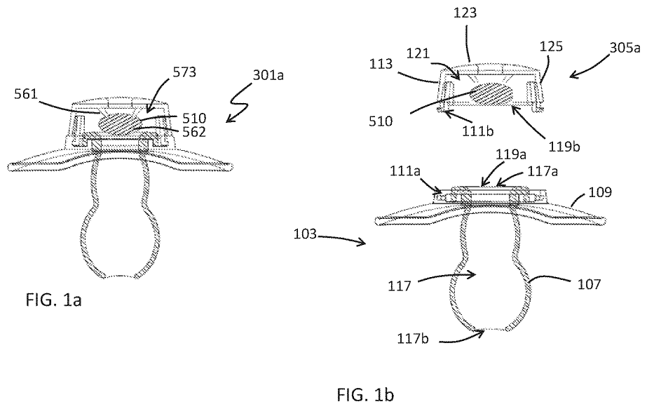

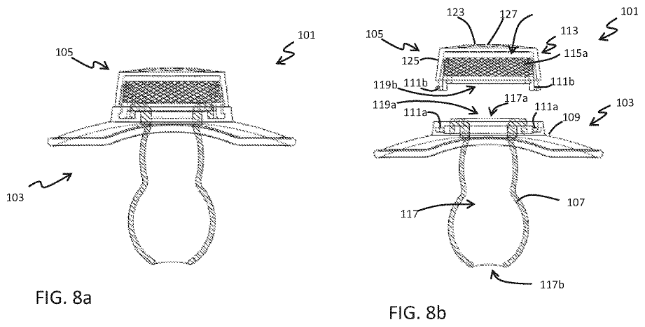

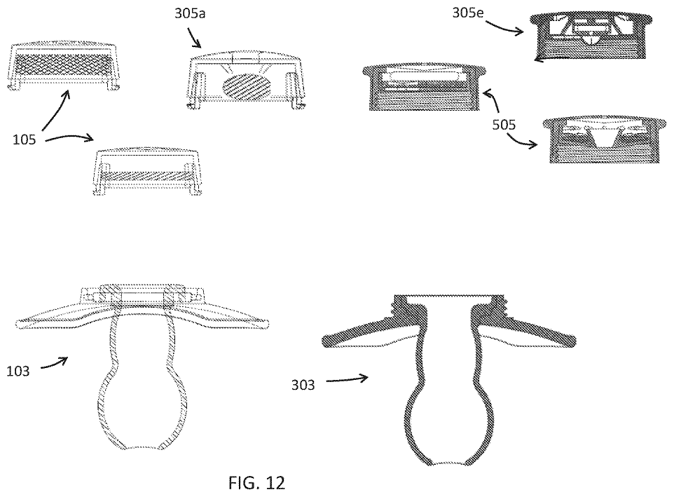

In FIGS. 1-7 a number of different embodiments of pacifiers 301a-g comprising a drug to be swallowed through the pacifier according to the invention are shown. Some of the details are the same or corresponding between the different embodiments and are also given the same or corresponding reference numbers. The different embodiments will be further described below with reference to each specific drawing but first a general description of the invention is given with reference to all the drawings 1-7. FIGS. 8-11 show a pacifier comprising a HME and/or a filter device and will be described further below. FIG. 12 show a pacifier system according to the invention and will be described further below.

According to the invention a pacifier 301a-301g comprising a suction part 103; 303; 303′ and a housing part 305a-305g is provided. The suction part 103; 303; 303′ comprises a nipple 107 and a shield 109 connected to each other. The suction part 103; 303; 303′ comprises further a passageway 117 through which a fluid can pass from outside a mouth of a user of the pacifier to inside the mouth of the user of the pacifier. The passageway 117 passes through the nipple 107 and the shield 109. The housing part 305a-305g comprises a housing 113, wherein said housing 113 is arranged to be prefilled with a drug 510 which can pass through the passageway 117 into the mouth of the user when the housing part 305a-305g is connected to the suction part 103; 303; 303′. The housing 113 of the housing part 305a-g is prefilled with the drug 510 and comprises hereby the drug 510.

In some embodiments of the invention the suction part 103; 303; 303′ is a reusable part and the housing part 305a-305g is an exchangeable part, wherein said reusable suction part 103; 303; 303′ and said exchangeable housing part 305a-305g are releasably connectable to each other. Therefore the suction part 103; 303; 303′ comprises in these embodiments at least one first connection device 111a and said housing part 305a-305g comprises at least one second connection device 111b which is releasably connectable to the at least one first connection device 111a. In all the embodiments as shown in FIGS. 1-7 the suction part 103; 303; 303′ and the housing part 305a-305g are releasably connected to each other. However, in another embodiment the suction part and the housing part can be provided connected to each other, i.e. not releasably connected to each other. Most of the details described below can be provided also for such a connected pacifier embodiment which will be apparent for a skilled person. The first and second connection devices 111a, 111b are shown to be recesses and protruding parts in FIGS. 1a and 1b and in most other embodiments the first and second connection devices 111a, 111b are shown to be mating threaded parts. In FIGS. 11a and 11b two other connection alternatives are shown comprising a rotational locking feature.

In FIGS. 1a-1b some features which are common for most of the embodiments are given reference numbers and will now be described. The passageway 117 comprises a first end 117a and a second end 117b between which a fluid can pass, which first end 117a is provided at a first connection interface 119a of the suction part 103; 303; 303′ configured for mating with a second connection interface 119b of the housing part 305a-g for embodiments where the suction part and the housing part are releasably connected. The second end 117b of the passageway 117 is provided in a part of the nipple 107 which is configured to be positioned within a user's mouth during use of the pacifier 301a-i, whereby a fluid can pass through the passageway 117 between the first connection interface 119a of the suction part 103; 303; 303′ and the inside of a user's mouth during use of the pacifier.

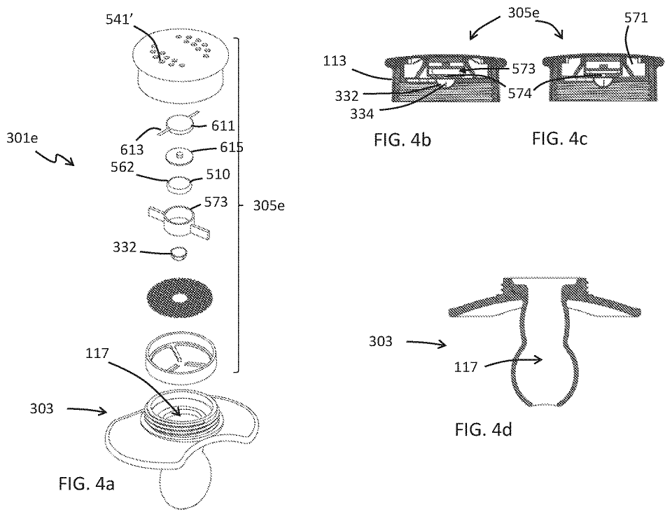

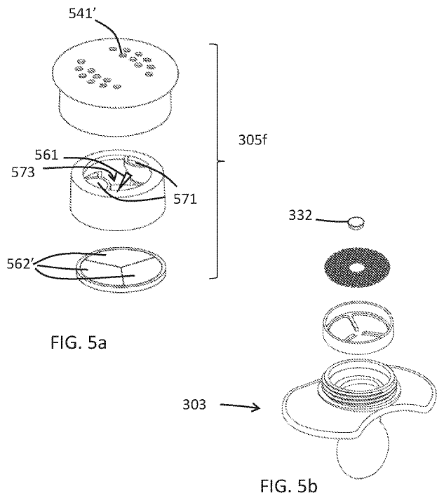

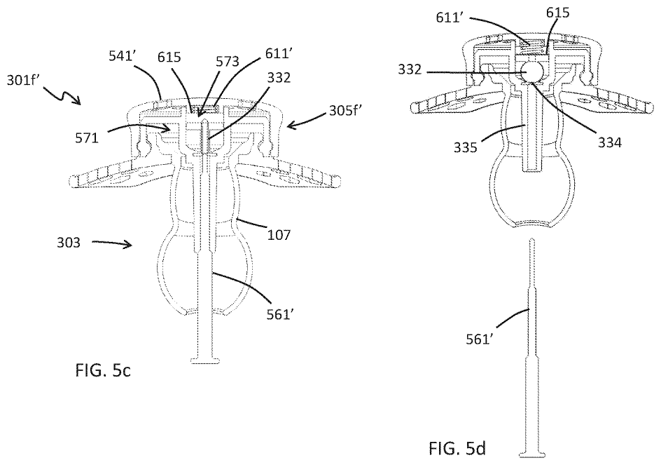

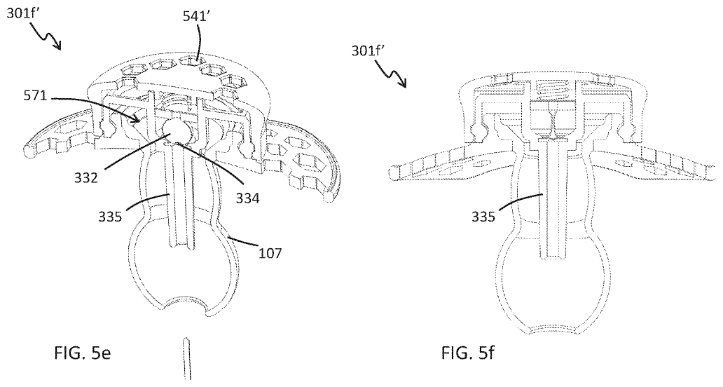

Furthermore, the housing 113 of the housing part 305a-g comprises an interior space 121 which is defined by a lid 123, surrounding walls 125 and the second connection interface 119b which is provided opposite the lid 123. The interior space 121 or a part of the interior space 121 is also called a drug compartment 573, see for example FIGS. 4a and 5a. The drug 510 is provided within the interior space 121 (and within the drug compartment 573) of the housing 113. The drug compartment 573 can in some embodiments of the invention comprise a narrow, extended outlet in the form a capillary tube 574. This can be seen in FIGS. 4b and 4c. Hereby the transferring of the drug from the drug compartment 573 toward the passageway 117 of the suction part 103; 303; 303′ can be better controlled and all the drug will not be provided at the same time but instead a suitable dosage of the drug may be provided. In some embodiments of the invention the drug 510 is provided inside a capsule 562 having a breakable capsule cover. A breakable capsule cover can comprise a material which will break when compressed or exposed to a force. The second connection interface 119b of the housing part 305a-g may be covered by a protective cover (not shown) like for instance a thin aluminium film or similar to protect the drug from contamination, from leaking and to ensure its shelf half-life. This protective cover can either be teared off by the user before use or be automatically teared open when the housing part and suction part are connected, for example by a protruding tearing device provided in the housing part or in the suction part.

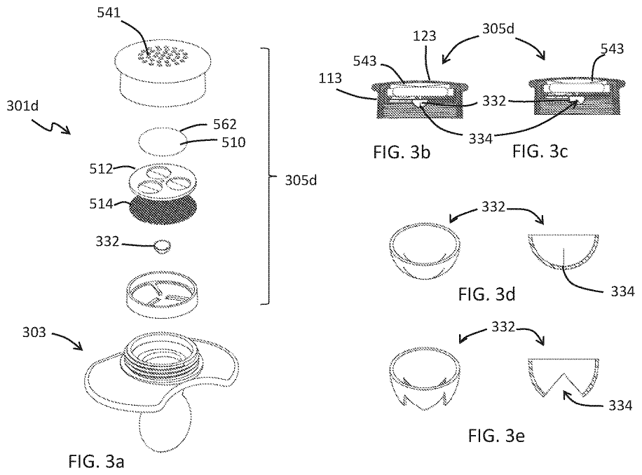

In some embodiments of the invention said housing 113 further comprises a drug collection cup 332 which can be positioned between the drug compartment 573 in which the drug 510 initially is provided and the passageway 117. In FIGS. 3 and 4 pacifiers 301d; 301e are shown comprising such a drug collection cup 332. The drug collection cup 332 is configured to collect drug 510 released from the drug compartment 573, possibly via a capillary tube 574 as shown in FIGS. 4b and 4c, before the drug is entering the passageway 117. The drug collection cup 332 comprises a valve 334 which is configured to open up and let fluid pass when a user of the pacifier sucks on the nipple producing a negative pressure which deforms the soft cup and opens the valve. This enables the user to only release the drug to the mouth while suckling which is a natural eating state. While breathing the cup remains closed, so not to inhale enteral drugs. A drug collection cup 332 comprising a valve 334 is shown in detail in closed state in FIG. 3d and in open state in FIG. 3e. The filling rate of the collection cup from the drug compartment 573 can in some embodiments of the invention be controlled via a capillary tube 574 attached to the drug compartment 573 as shown in FIGS. 4b and 4c. The capillary tube 574 can be designed to have a specific resistance, thus determining the flow rate. Such a drug collection cup 332 and/or a capillary tube 574 can be provided also in the other embodiments of the invention. The drug collection cup 332 can be provided between the drug compartment 573 and the passageway 117. The drug collection cup 332 can be provided in the housing part 305a-g as shown in FIGS. 3, 4 and 5 but in another embodiment of the invention the drug collection cup 332 is instead provided in the suction part 103; 303; 303′, somewhere inside the passageway 117. The drug collection cup 332 is provided for allowing a suitable distribution of the drug and for avoiding all drug to enter the first end 117a of the passageway 117 at the same time.

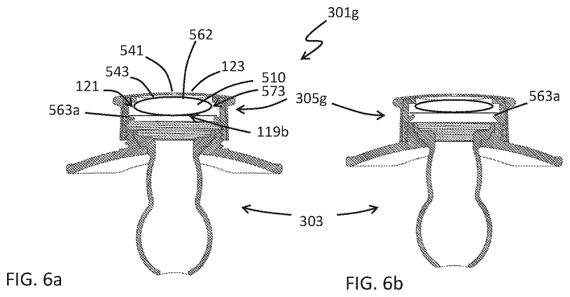

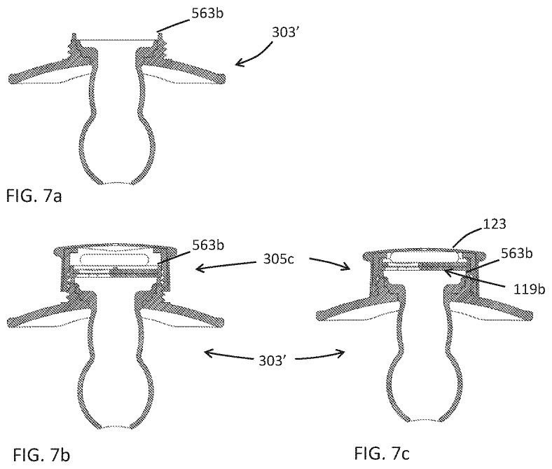

The drug capsule 562 may have a size such that the capsule 562 will be compressed and broken when the suction part 103; 303; 303′ and the housing part 305a-g are connected, i.e. the drug capsule may have a larger size than the interior space 121 of the housing part when the housing part and the suction part are connected. An interior space 121 may be compressed when the housing part and the suction part are connected which is further described in relation to FIGS. 6 and 7.

In some embodiments of the invention, as for example shown in FIGS. 1 and 5a, said housing part 305a; 305f further comprises at least one piercing member 561 arranged for piercing a drug capsule 562; 562′ in which said drug 510 is provided when said housing part 305a; 305f is provided in a certain position in relation to the suction part 103; 303; 303′ hereby allowing the drug 510 to be released at a certain moment. In the embodiment shown in FIGS. 1a and 1b the piercing member 561 may be configured to pierce the drug capsule 562 when the housing part 305a and the suction part 103 are connected. However, it could also be required to provide for example a rotation to the housing part 305a when the housing part and the suction part are connected in order to pierce the drug capsule 562. In FIG. 5a an embodiment of the invention is shown wherein said drug 510 is provided in more than one drug capsule 562′ and wherein said housing part 305f can be provided in more than one different positions in relation to the suction part 103; 303; 303′ whereby said piercing member 561 will be piercing one drug capsule 562′ in each of said positions. This allows for multiple dosing with manually controlled intervals. In FIGS. 5c-f another type of drug releasing device 561′ is shown by which an opening can be provided into the drug compartment 573 by operating the drug releasing device 561′ from outside the pacifier.

In FIGS. 6 and 7 features of the invention which will provide a possibility to compress an interior space 121 within the housing 113, possibly for breaking a capsule 562 and releasing the drug 510, are described. The housing part 305a-g or the suction part 103; 303; 303′ may comprise at least one protruding part 563a, 563b. The at least one protruding part 563a, 563b may be provided to the first or second connection devices 111a, 111b. The at least one protruding part 563a, 563b will push the second connection interface 119b towards the lid 123 when the housing part 305a-g and the suction part 103; 303; 303′ are connected whereby a pressure will be provided to the interior space 121. Hereby a drug capsule 562 may be broken by said pressure and the drug 510 is released and/or an increased pressure inside the housing 113 may be suitable for the drug delivery. In FIGS. 6a-6b a protruding part 563a is provided to the second connection device 111b, i.e. to the housing part 305g. The protruding part 563a is in this embodiment provided at an inner surface of the housing 113 pointing towards a centre of the housing 113 before connection of the suction part and the housing part. The protruding part 563a is provided at a position such that when the suction part and the housing part are connected the connection device 111a of the suction part will press the protruding part 563a in a direction towards the lid 123 of the housing part. Hereby the at least one protruding part 563a is flexible to some extent. When the protruding part 563a changes direction and points towards the lid 123, as shown in FIG. 6b, the second connection interface 119b of the housing part 305g will be pressed closer to the lid 123 whereby a volume of the interior space 121 will decrease and a capsule 562 may be broken for releasing the drug. In FIGS. 7a-7c another alternative is shown where a protruding part 563b is provided to the suction part 303′. The at least one protruding part 563b is in this example protruding towards a lid 123 of the housing part. In FIG. 7b a first connection state is shown before the suction part and the housing part are completely connected. The protruding part 563b will accomplish a compression of the interior space 121 when the connection is completed as is seen in FIG. 7c.

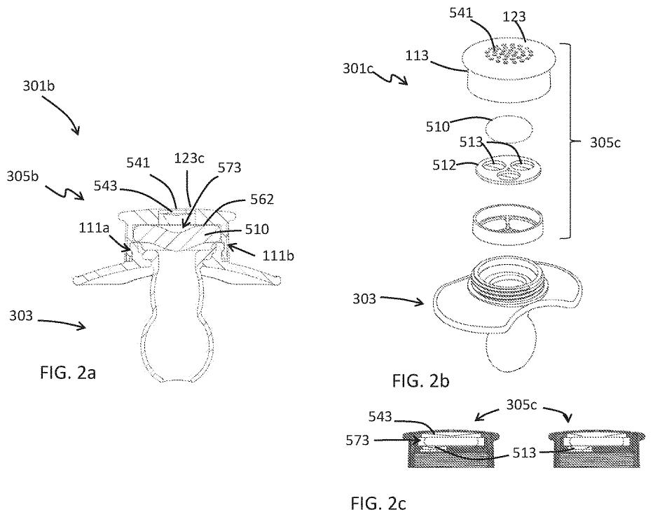

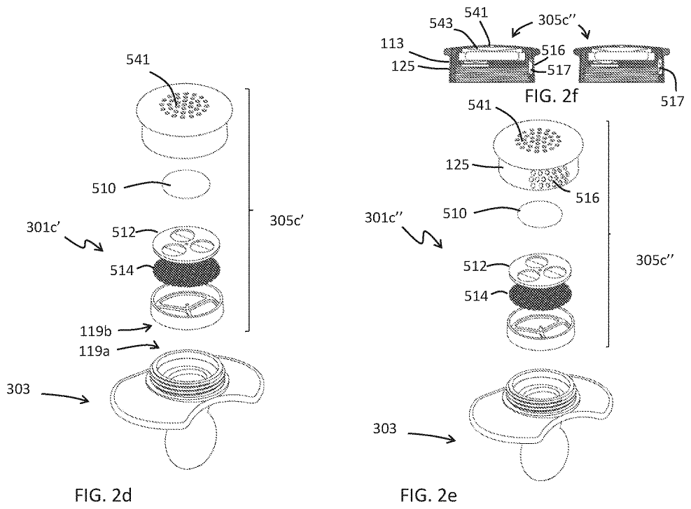

In some embodiments of the invention, as shown in FIGS. 2, 3 and 6, the housing 113 comprises at least one air inlet 541, whereby air can be drawn into a drug compartment 573 of the housing 113 where the drug initially is provided, through said air inlet 541 by a user of the pacifier 301a-301g when the user is sucking on the nipple 107 of the suction part 103; 303; 303′. The air inlet 541 can be provided with at least one valve 543 such that passage of air via said at least one air inlet 541 only is admitted into and not out from said housing 113. Hereby vacuum is avoided in the drug compartment 573 and the drug can conveniently be delivered through the passageway 117 by sucking on the nipple 107 by the user. In addition, or alternatively, separate air channels 571 can be provided which enables for air passage parallelly to the drug compartment which is shown in FIGS. 4 and 5.

In FIGS. 4 and 5 embodiments of the invention are shown wherein at least one separate air channel 571 is provided in the housing part 305e; 305f; 305f′ wherein said at least one separate air channel 571 is provided in fluid connection to at least one open air inlet 541′ of the housing part 305e; 305f; 305f′ which is not in communication with a drug compartment 573 of the housing 113 where the drug initially is provided and wherein said open air inlet 541′ is open for passage of air in both directions. Hereby a user of the pacifier can also breath through the pacifier 301e; 301f; 301f′.

In FIGS. 4a-4d a pacifier 301e according to one embodiment of the invention is shown where the housing 113 of said housing part 305e comprises a pressurized chamber 611 which can be activated for providing a pressure to the drug 510. The pressurized chamber 611 comprises a releasing device 613, whereby said releasing device 613 can be moved by an air flow provided through the pacifier during inhalation by a user. The pressurized chamber 611 is activated by a movement of said releasing device 613 for providing a pressure to the drug for transferring the drug to the passageway 117 of the suction part 303; 303′; 103, possibly via a drug collection cup 332 as shown in FIGS. 4a-4c. The releasing device 613 is here shown to be two protruding parts, however the number can of course be different. The protruding parts are deflecting towards the suction part during inhalation. When the protruding parts are deflecting the pressurized chamber 611 is not active. However, when a user stops to inhale the protruding parts 613 are released towards a horizontal direction and this will activate the pressurized chamber 611. A pressure transferring device 615 in the form of a plate or piston will be forced towards the drug 510 by the pressure released form the pressurized chamber 611 whereby the drug capsule 562 will be compressed, which is seen in FIGS. 4b and 4c. Thus the flow of drug is stopped when the user is inhaling, preventing inhalation of enterally acting drugs. As already described above a capillary tube 574 is in this embodiment provided between the drug compartment 573 and the drug collection cup 332. The capillary tube 574 can be seen in FIGS. 4b and 4c and it's function is to control the transfer of drug from the drug compartment 573 such that drug can be received by the user of the pacifier in a suitable amount and a suitable flow. A capillary tube 574 can be provided to the drug compartment 573 in all the embodiments of the invention. Instead of a pressurized chamber a biased resilient member 611′, such as a spring, can be provided in the housing part 305f as shown in FIGS. 5c-f. When the biased resilient member 611′ is released it will push a pressure transferring device 615 inside the drug compartment 573 such that the volume of the drug compartment 573 is decreasing and the drug is forced out from the drug compartment.

Each of the illustrated embodiments will now be described briefly in addition to the description given above.

In FIGS. 1a-1b a pacifier 301a is shown comprising an exchangeable housing part 305a and a reusable suction part 103. The exchangeable housing part 305a comprises a drug 510 in a drug capsule 562. A piercing member 561 is provided in the housing part 305a which piercing member 561 is configured to pierce the drug capsule 562 and release the drug into the drug compartment 573 when the housing part 305a and the suction part 103 are connected.

In FIG. 2a a pacifier 301b according to another embodiment is shown. A housing part 305b is also in this embodiment exchangeable and the suction part 303 is reusable. A first and a second connection device 111a, 111b are in this embodiment threaded mating devices. An air inlet 541 can be seen in this embodiment in a lid 123 of the housing part 305b. The air inlet 541 is provided with a valve 543 such that air can be transferred into an interior 121 of the housing 113 where the drug 510 is provided, i.e. into the drug compartment 573, but not out through the air inlet 541.

In FIG. 2b a pacifier 301c according to still another embodiment of the invention is shown. The pacifier 301c comprises an exchangeable housing part 305c and a reusable suction part 303. The exchangeable housing part 305c comprises in this embodiment a valve membrane 512 onto which the drug 510 is provided initially, i.e. before the drug 510 is delivered through the pacifier 301c to the user. The drug compartment 573 is hereby provided between the valve membrane 512 and a lid 123 of the housing 113 in this embodiment. The valve membrane 512 ensures that the drug 510 is kept inside the drug compartment 573 until a user of the pacifier 301c starts to suck on the nipple 107, which sucking will open valves 513 in the valve membrane 512 whereby the drug 510 can be transferred through the passageway 117 to the user. Such a valve membrane 512 can be provided in all the embodiments of the invention but is not necessarily provided. In this embodiment of the invention three valves 513 are provided in the valve membrane 512, however any number of valves 513 can of course be provided. In FIG. 2c one of the valves 513 in the valve membrane 512b can be seen in an open and a closed state respectively.

In FIG. 2d a pacifier 301c′ which is similar to the pacifier shown in FIGS. 2b and 2c is shown. The only difference is that a filter 514 is provided in the housing part 305c′ at an outlet side of the valve membrane 512, i.e. between the valve membrane 512 and a second connection interface 119b of the housing part 305c′, which second connection interface 119b is configured to be connected to a first connection interface 119a of the suction part 303 when the housing part 305c′ and the suction part 303 are connected. The filter 514 can control a speed of the flow of drug by its pore seizes.

In FIGS. 2e and 2f still another embodiment of a pacifier 301c″ according to the invention is shown. In this embodiment of the invention a housing part 305c″ of the pacifier 301c″ comprises exhale outlets 516. The exhale outlets 516 are in this embodiments provided in a surrounding wall 125 of the housing 113 and are provided with a valve 517. The valve 517 can be seen in an open and in a closed state in FIG. 2f. Hereby exhalation air is directed out through the exhale outlets 516 and not through the air inlet 541. The air inlet 541 comprises a valve 543 which will only allow air to be inhaled and not exhaled. In FIG. 2f it can be seen that the valve 543 is closed when the valve 517 is open and vice versa. Hereby conditioned exhaled air can be directed towards the respiratory orifices of the user to reduce an amount of hazardous substances to be inhaled. Hereby inhaled air can be directed through the drug compartment 573 and exhaled air can be directed outside the drug compartment 573 and out through a surrounding side wall 125 of the housing 113. The valves 543, 517 of the housing part 305c″ are arranged to accomplish this. Such exhale outlets 516 can be provided also to the other embodiments of the invention.

In FIGS. 3a-3c still another embodiment of a pacifier 301d according to the invention is shown. In this embodiment of the invention a housing part 305d of the pacifier 301d comprises a drug collection cup 332 with a valve 334. This has been described above and will not be described in detail again. In this embodiment the housing part 305d further comprises a valve membrane 512 and a filter 514 as described in relation to FIG. 2d, however a drug collection cup 332 can also be provided in embodiments without valve membrane 512 and filter 514. In FIG. 3b both a valve 543 provided to the air inlet 541 in the lid 123 of the housing 113 and the valve 334 of the drug collection cup 332 are shown in a closed state and in FIG. 3c the two valves 543, 334 are provided in an open state. The drug collection cup 332 is shown in detail in FIGS. 3d (closed state) and 3e (open state).

FIGS. 4a-4d show a pacifier 301e according to still another embodiment of the invention comprising a pressurized chamber 611 and a drug collection cup 332 as already described in detail above.

FIG. 5a shows a part of a housing part 305f according to another embodiment of the invention. In this embodiment the housing part 305f comprises a piercing member 561 and the drug 510 is provided in more than one drug capsule 562′. The housing part 305f can be rotated such that the piercing member 561 can pierce one drug capsule 562′ in each position whereby different doses of drugs can be provided at different times. A drug collection cup 332 can be provided also to this embodiment which is shown in FIG. 5b.

FIGS. 5c-5f show in cross section a pacifier 301f′ according to the invention. Also this pacifier 301f′ comprises a housing part 305f and a suction part 303 whereby the housing part 3051′ can be an exchangeable part and the suction part 303 can be a reusable part. The housing part 305f may be releasably connectable to the suction part 303. However, the housing part and the suction part can also be provided connected to each other, i.e. non releasably connected. The pacifier 301f′ according to this embodiment comprises a drug collection cup 332 which is positioned in the pacifier and configured for collecting drug released from the drug compartment 573 before the drug is received by a user. Said drug collection cup 332 comprises a valve 334 which is configured to open up and let fluid pass when a user of the pacifier sucks on the nipple. Walls of said drug collection cup 332 are made from a flexible material. Hereby the drug collection cup 332 can expand when receiving drug from the drug compartment 573 which can be seen in FIGS. 5d and 5e. In FIG. 5c the drug is initially provided in the drug compartment 573 and the drug collection cup 332 is not yet expanded. This is a delivery state and the drug is safely stored inside the drug compartment 573. Before the drug can be delivered to a user of the pacifier it has to be released from the drug compartment 573. The drug compartment 573 needs to be opened in some way. This can be done in different ways, for example by a piercing member or by increasing the pressure to a drug capsule as described in relation to the other embodiments of the invention. In this embodiment the pacifier 301f′ comprises a drug releasing device 561′ by which an opening can be provided into the drug compartment 573, which drug releasing device 561′ can be operated from outside the pacifier. One example of a drug releasing device 561′ is a piercing device which can be guided into the housing part 305f′ of the pacifier via the nipple 107. Such a piercing device can possibly be delivered together with the pacifier and already positioned pointing into the pacifier through the nipple reaching to the drug compartment 573 but leaving a rear end reachable outside the pacifier. When the drug should be released the piercing device can be controlled from outside the pacifier to pierce the drug compartment 573 and then the piercing device is removed from the pacifier. Another example of a drug releasing device 561′ comprises a closure which is covering an opening in the drug compartment 573. In this example the drug releasing device 561′ comprises also a removing strip connected to the closure, which removing strip is reaching out from the pacifier for a user to grab for removing the closure in order to release the drug from the drug compartment.

When an opening has been provided to the drug compartment 573 and the drug has been released the drug starts to fill up the drug collection cup 332 which can be seen in FIGS. 5d and 5e. The drug collection cup 332 is in this embodiment flexible and will expand when it is filled by the drug. In this embodiment there is no air inlet connected to the drug compartment 573 as in many of the previous embodiments. However, thanks to the flexible walls of the drug collection cup 332 the drug can be delivered to the user anyway.

When the user of the pacifier sucks on the nipple 107 the valve 334 of the drug collection cup 332 is opening and drug is transferred out from the drug collection cup 332, via a drug transferring tube 335 and via the nipple 107 to the user. The valve 334 can be designed such that the user of the pacifier needs to suck with a certain intense, i.e. provide a certain under pressure, for opening the valve 334. Hereby it is assured that drug is only released from the drug collection cup 332 when the user of the pacifier is eating, i.e. the drug will not be transferred to the user when the user is only breathing. Hereby there is less risk that the user of the pacifier will inhale the drug by mistake.

In FIG. 5f it can be seen how both the drug compartment 573 and the drug collection cup 332 have been emptied after the drug has been delivered to the user. The drug collection cup 332 has collapsed again. The flexible material of the drug collection cup 332 allows for an efficient transferring of the drug which will work properly also without any air inlet. Hereby, as discussed above, there are no air inlets provided into the drug compartment 573 in this embodiment of the invention. However, there is at least one separate air channel 571 provided in the housing part 305f′, wherein said at least one separate air channel 571 is provided in fluid connection to at least one open air inlet 541′ of the housing part 305f′ which is not in communication with the drug compartment 573 where the drug initially is provided and wherein said open air inlet 541′ is open for passage of air in both directions. Hereby a user of the pacifier can breathe through the pacifier.

The pacifier 301f′ of this embodiment comprises as mentioned above a drug transferring tube 335 which is extending from the drug collection cup 332 through at least a part of the nipple 107 of the suction part 303, wherein said drug transferring tube 335 is less flexible than the nipple 107 whereby drug can be transferred through the drug transferring tube 335 even if the nipple 107 is compressed. Less flexible would mean that the material of the drug transferring tube 335 is less flexible, i.e. more rigid than the material of the nipple 107. Hereby the drug transferring tube will keep its shape even if the nipple 107 is compressed by the mouth and tongue of the user of the pacifier when the user is sucking on the pacifier. The drug transferring tube 335 can suitably reach at least a part of the length of the nipple 107, such as at least one third or one half of the length of the nipple 107. The drug transferring tube 335 is in this embodiment a part of the housing part 301f′ and is provided pointing into the nipple 107 of the suction part 303 when the housing part 301f′ and the suction part 303 are connected. However, the drug transferring tube 335 could as well instead be a part of the suction part 303.

For transferring the drug from the drug compartment 573 to the drug collection cup 332 a pressure can suitably be provided to the drug compartment 573. The drug compartment 573 can possible be pressurized at production or a pressure can be applied by a pressure device 611; 611′. There are different possible methods for providing a pressure to the drug compartment 573 and some methods have already been described above. By providing a pressure to the drug compartment it can be assured that all drug is transferred from the drug compartment and this is suitable for example when a dose of a drug to be administered needs to be exact. The pacifier 301f′ of this embodiment comprises a biased resilient member 611′, such as a spring, which is provided in the housing part 3051′. When the biased resilient member 611′ is released it will push a pressure transferring device 615 inside the drug compartment 573 such that the volume of the drug compartment 573 is decreasing and the drug is forced out from the drug compartment. The biased resilient member 611′ will be released when the drug releasing device 561′ is operated to provide an opening into the drug compartment 573. In FIG. 5c the resilient member 611′ is biased, i.e. in an initial position before the drug has been released. In FIGS. 5d and 5e the drug has been transferred into the drug collection cup 332. The pressure transferring device 615 has been moved by the resilient member 611′ inside the drug compartment 573 such that the drug has been transferred from the drug compartment 573 to the drug collection cup 332. Another method for providing a pressure for transferring the drug can also be used, such as for example a pressurized chamber 611 as described in relation to the embodiment as shown in FIG. 4.

FIGS. 8, 9 and 10 show schematically pacifiers comprising at least one of a HME device and/or a filter device which are very similar. Details which are the same are given the same reference numbers.

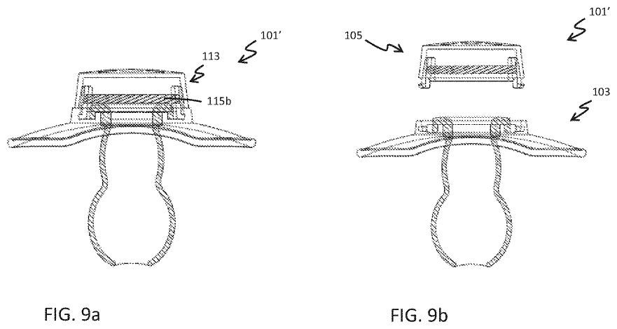

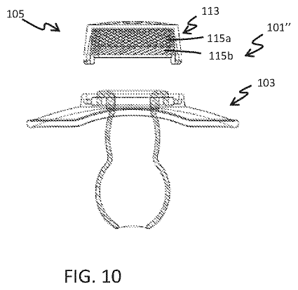

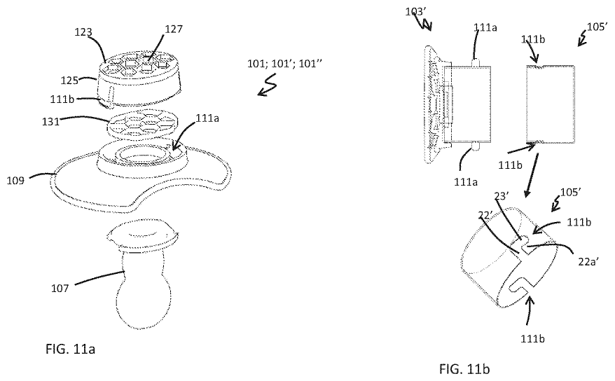

In FIGS. 8a and 8b a pacifier 101 comprising a HME device 115a is shown in assembled (FIG. 8a) and separated (FIG. 8b) positions. In FIGS. 9a and 9b a pacifier 101′ comprising a filter device 115b is shown in assembled (FIG. 9a) and separated (FIG. 9b) positions. In FIG. 10 a pacifier 101″ comprising both a HME device 115a and a filter device 115b is shown in separated position. FIG. 11a shows a pacifier in exploded view. This could be any of the embodiments as shown in FIGS. 8-10. No filter device or HME device is shown in FIG. 11a. All these embodiments will now be described together referring to FIGS. 8-11.

A pacifier 101; 101′; 101″ is provided which comprises a reusable suction part 103 and at least one exchangeable housing part 105 which are releasably connectable to each other. A pacifier system can also be provided comprising one suction part 103 and more than one housing parts 105 which are intended for use with the same suction part 103. Hereby the suction part 103 can be reused together with different housing parts 105. The housing parts 105 can be changed due to a need for changing or cleaning of the HME device 115a or filter device 115b provided therein or because there is a need for another type of HME device 115a or filter device 115b. Hereby the pacifier 101; 101′; 101″ can be delivered as a kit with one suction part 103 and a number of housing parts 105. As a first option it is intended that the housing part is completely exchanged, i.e. the housing part is a single use part which is disposed after use. However, alternatively, instead of changing the whole housing part, the housing part can be released from the suction part and the filter device and/or HME device can be changed to a new one or cleaned for reuse.

The suction part 103 comprises a nipple 107 and a shield 109 connected to each other. The nipple 107 is configured to be sucked by a child and the shield 109 is provided for preventing swallowing of the nipple 107 as is common for pacifiers. According to the invention the suction part 103 comprises a passageway 117 through which a fluid can pass from outside a mouth of a user of the pacifier 101; 101′; 101″ to inside the mouth of the user of the pacifier. Hereby the pacifier 101; 101′; 101″ is a breath-through pacifier which is suitable to use for example when nose breathing is inhibited.

The suction part 103 comprises furthermore at least one first connection device 111a for connection with the housing part 105. The housing part 105 comprises a housing 113 and at least one second connection device 111b which is releasably connectable to the at least one first connection device 111a. In this embodiment the first connection device 111a comprises two opposing recesses and the second connection device 111b comprises two protruding parts, whereby the recesses are configured to receive the protruding parts when the suction part 103 and the housing part 105 are connected. For allowing the protruding parts to enter the recesses the protruding parts may be resilient. Another alternative is that for example the shield 109 is resilient and can be bent to allow the protruding parts to enter into the recesses. A still further alternative is shown in relation to FIG. 11b and will be further described below. In the embodiment described in relation to FIG. 11b the protruding parts do not need to be resilient. The number of recesses and protruding parts can of course be another than two. Furthermore, the recesses could as well be provided in the housing part 105 and the protruding parts in the suction part 103. For improving the connection and securing the connection a rotational locking feature can as well be provided. By rotating the housing part 105 in relation to the suction part 103 when they have been connected the first and second connection devices 111a, 111b can be provided in a locking position. For example the recesses can be provided as grooves allowing protruding parts to be guided in the grooves when the housing part is rotated.

An alternative connection and locking mechanism which can be used for connecting a suction part 103′ (nipple not shown in this view) and a housing part 105′ of a pacifier according to the invention is shown in FIG. 11b. In this embodiment of the locking mechanism a first connection device 111a provided in the suction part 103′ comprises two protruding parts (however, the number of protruding parts can of course be varied). A second connection device 111b is provided in the housing part 105′ and comprises two recesses 22′ for receiving the protruding parts and a channel 23′ into which the protruding parts 111a can be rotated, i.e. the recesses and channels allows rotation of the housing part in relation to the suction part when the protruding parts have been received in the recesses. A locking edge 22a′ locks the protruding parts 111a within the channels 23′. The dimensions of the protruding parts 111a, the recesses 22′ and the channels 23′ can be provided such that friction between the parts keeps them connected to a requested strength but allows disengaging of the two parts. Furthermore, an inward angle of the channel 23′ in relation to the recess 22′ or an additional channel directed inwards can be adopted such that the housing part 105′ needs to be pushed towards the somewhat inertially recoiling suction part 103′ for allowing the rotation of the protruding parts 111b in the channels 23′. The channel thus forms more of a “U”-shape, with the tips of the U directed towards the suction part 103′.

Said housing 113 comprises at least one heat and moisture exchanger (HME) device 115a and/or at least one filter device 115b. In the embodiment as shown in FIGS. 8a and 8b the housing 113 comprises only a HME device 115a. In the embodiment as shown in FIGS. 9a and 9b the housing 113 comprises only a filter device 115b and in the embodiment as shown in FIG. 10 the housing 113 comprises both a HME device 115a and a filter device 115b.

The passageway 117 comprises a first end 117a and a second end 117b between which a fluid can pass, which first end 117a is provided at a first connection interface 119a of the suction part 103 which is configured for mating with a second connection interface 119b of the housing part 105. The second end 117b of the passageway 117 is provided in a part of the nipple 107 which is configured to be positioned within a user's mouth during use of the pacifier 101; 101′; 101″, whereby a fluid can pass through the passageway 117 between the first connection interface 119a of the suction part 103 and the inside of a user's mouth during use of the pacifier. The passageway 117 is hereby extending through the nipple 107 and through the shield 109.

The housing 113 of the housing part 105 comprises an interior space 121 which is defined by a lid 123, surrounding walls 125 connected to the lid 123 and the second connection interface 119b which is provided opposite the lid 123. Said second connection interface 119b is at least partly open into the interior space 121 of the housing 113 and is configured for mating with the first connection interface 119a of the suction part 103.

Furthermore, the lid 123 comprises air openings 127 through which air can pass. The HME device 115a and/or the filter device 115b are provided within the interior space 121 of the housing 113 such that air passing between the air openings 127 in the lid 123 and the second connection surface 119b of the housing 113 also has to pass the HME device 115a and/or the filter device 115b.

In some embodiments the HME device 115a and/or the filter device 115b can be secured within the interior space 121 of the housing 113 by at least one grating 131 which is welded to the surrounding walls 125. Such a grating is shown in FIG. 11a.

According to the invention a pacifier system is also provided. This is illustrated in FIG. 12. A pacifier system according to the invention comprises a reusable suction part 303; 303′; 103 and at least two exchangeable housing parts 305a-g; 105; 505. The exchangeable housing parts 305a-g; 105; 505 can comprise a drug to be swallowed (enteral drug) as described in relation to FIGS. 1-7, a drug to be inhaled (illustrated by 505 in FIG. 12), a heat and moisture exchanger (HME) device or a filter or more than one of these different examples in combination. For example an exchangeable housing part may comprise both a drug and a filter. By providing a pacifier system one suction part 103; 303 can be used for different types of housing parts 105, 305; 505 and a suitable housing part can be provided for different occasions. Furthermore, new housing parts can be provided when the first one is empty of drug or when a filter needs to be changed. Hereby a user friendly and environmentally friendly product which is flexible for different needs is achieved.

1. A pacifier comprising a suction part and a housing part,
wherein said suction part comprises a nipple and a shield connected to each other,
wherein said suction part comprises a passageway through which a fluid can pass from outside a mouth of a user of the pacifier to inside the mouth of the user of the pacifier,
and wherein said housing part comprises a housing, wherein said housing comprises a drug compartment which is arranged to be prefilled with a drug which can pass through the passageway into the mouth of the user when the housing part is connected to said suction part, wherein said pacifier further comprises a drug collection cup which is positioned in the pacifier and configured for collecting drug released from the drug compartment before the drug is received by a user and wherein said drug collection cup comprises a valve which is configured to open up and let fluid pass when a user of the pacifier sucks on the nipple.

2. Pacifier according to claim 1, wherein the suction part is a reusable part and the housing part is an exchangeable part, wherein said reusable suction part and said exchangeable housing part are releasable connectable to each other, wherein said suction part comprises at least one first connection device and wherein said housing part comprises at least one second connection device which is releasably connectable to the at least one first connection device.

3. Pacifier according to claim 1, wherein said housing comprises at least one air inlet, whereby air can be drawn into the drug compartment through said air inlet by a user of the pacifier when the user is sucking on the nipple of the suction part.

4. Pacifier according to claim 1, wherein walls of said drug collection cup are made from a flexible material.

5. Pacifier according to claim 1, further comprising a drug transferring tube which is extending from the drug collection cup through at least a part of the nipple of the suction part, wherein said drug transferring tube is less flexible than the nipple whereby drug can be transferred through the drug transferring tube even if the nipple is compressed.

6. Pacifier according to claim 1, further comprising a drug releasing device by which an opening can be provided into the drug compartment, which drug releasing device can be operated from outside the pacifier.

7. Pacifier according to claim 1, wherein a capillary tube is provided at an outlet from the drug compartment for transferring the drug out from the drug compartment.

8. Pacifier according to claim 1, wherein the drug is provided inside a capsule having a breakable capsule cover, and
wherein the drug capsule has a size such that the capsule will be compressed and broken when the suction part and the housing part are connected.

9. (canceled)

10. Pacifier according to claim 1, wherein said housing part further comprises at least one piercing member arranged for piercing a drug capsule in which said drug is provided when said housing part is provided in a certain position in relation to the suction part hereby allowing the drug to be released at a certain moment.

11. Pacifier according to claim 10, wherein said drug is provided in more than one drug capsule and wherein said housing part can be provided in more than one different positions in relation to the suction part whereby said piercing member will be piercing one drug capsule in each of said positions.

12. Pacifier according to claim 1, wherein said passageway comprises a first end and a second end between which a fluid can pass, which first end is provided at a first connection interface of the suction part configured for mating with a second connection interface of the housing part and which second end of the passageway is provided in a part of the nipple which is configured to be positioned within a user's mouth during use of the pacifier, whereby a fluid can pass through the passageway between the first connection interface of the suction part and the inside of a user's mouth during use of the pacifier, and
wherein the housing of the housing part comprises an interior space which is defined by a lid, surround walls and a second connection interface which is provided opposite the lid, wherein said second connection interface is configured for mating with the first connection interface of the suction part.

13. (canceled)

14. Pacifier according to claim 1, wherein the suction part or the housing part, comprises at least one protruding part which will push a second connection interface of the housing part which is configured to mate with a first connection interface of the suction part, towards a lid of the housing part when the housing part and the suction part are connected whereby a pressure will be provided to an interior space of the housing comprising the drug, said interior space being provided between the second connection interface and the lid.

15. Pacifier according to claim 1, wherein said air inlet is provided with at least one valve such that passage of air via said at least one air inlet only is admitted into and not out from said housing.

16. Pacifier according to claim 1, wherein at least one separate air channel is provided in the housing part, wherein said at least one separate air channel is provided in fluid connection to at least one open air inlet of the housing part which is not in communication with a drug compartment of the housing where the drug initially is provided and wherein said open air inlet is open for passage of air in both directions.

17. Pacifier according to claim 1, wherein said housing of said housing part comprises a pressurized chamber or a biased resilient member which can be activated for providing a pressure to the drug for transferring the drug to the passageway of the suction part.

18. Pacifier according to claim 17, wherein said pressurized chamber comprises a releasing device, whereby said releasing device can be moved by an air flow provided through the pacifier during inhalation by a user, whereby said pressurized chamber is activated by a movement of said releasing device for providing a pressure to the drug for transferring the drug to the passageway of the suction part, possibly via a drug collection cup.

19. An exchangeable housing part configured to be used in a pacifier according to claim 1, wherein said housing part comprises a housing and at least one second connection device which is releasably connectable to at least one first connection device provided in the suction part,
wherein said housing part comprises a housing, wherein said housing comprises a drug compartment which is arranged to be prefilled with a drug which can pass through the passageway into the mouth of the user when the housing part is connected to said suction part, wherein said pacifier further comprises a drug collection cup which is positioned in the pacifier and configured for collecting drug released from the drug compartment before the drug is received by a user and wherein said drug collection cup comprises a valve which is configured to open up and let fluid pass when a user of the pacifier sucks on the nipple.

20. A pacifier system comprising a pacifier according to claim 1, wherein the housing part is an exchangeable housing part and wherein the pacifier system comprises at least two exchangeable housing parts.

21. A pacifier system comprising a pacifier according to claim 1, wherein the housing part is an exchangeable housing part and wherein the pacifier system further comprises at least one exchangeable housing part comprising at least one heat and moisture exchanger (HME) device and/or at least one filter device.
